(19) United States
(12) Patent Application Publication
(10) Pub. No.: US 2008/0029127 A1
(43) Pub. Date: Feb. 7, 2008

(54) METHOD OF APPLYING SOLUTION OF OIL REPELLENT

(75) Inventors: Daichi HIMEKAWA, Minami-ku (JP); Terutaka MASUMOTO, Minami-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Kyoto (JP)

(21) Appl. No.: 11/835,138

(22) Filed: Aug. 7, 2007

(30) Foreign Application Priority Data
Aug. 7, 2006 (JP) 2006-214216

(51) Int. Cl. B05D 1/28

(52) U.S. Cl. 134/6

(57) ABSTRACT

First, an object and an applicator for supplying a solution prepared by dissolving an oil repellent in a volatile solvent are arranged with an end of the applicator and the object substantially away from each other. Then, the solution is supplied from a solution reservoir for storing the solution to the applicator through a solution passage connecting the solution reservoir and the applicator to each other, and thereafter the solution is made to ooze from the end of the applicator while one of the object and the applicator is moved relative to the other. A space between the object and the end of the applicator is filled with the solution and a distance between the object and the end of the applicator is determined to allow the solution to be held in the space by surface tension.

### BACKGROUND OF THE INVENTION

1. Field of the Invention

The present invention relates to a method of applying a solution of an oil repellent to a desired portion on a surface of an object. More particularly, the present invention relates to a method of applying a low-viscosity solution prepared by dissolving a fluorine-based oil repellent resin in a highly volatile organic solvent.

2. Description of the Related Art

The method of forming an oil repellent film on a desired portion of a machine component includes a method in which a solution prepared by dissolving an oil repellent in a solvent is applied to the desired portion and the solvent is then volatilized.

However, when the resultant oil film, after the volatilization of the solvent, is too thick or uneven, the film is liable to peel off. To prevent the peeling off, the concentration is adjusted to be sufficiently low to form a thin oil repellent film. Alternately, a low-viscosity solvent with a high flow property is used to impart sufficiently low viscosity to the solution, so that the solution can be coated evenly. It is nonetheless difficult to achieve satisfactorily even and thin coating of the solution, and various methods have been tried therefor.

JP 6-171081 A1, JP 2002-48133 A1, and JP 2004-211851, for example, disclose methods of applying the solution such as brushing-on, spraying, to be coated, spin coating, transferring, and dropping the solution on a desired portion using, e.g., a brush. Further proposed is a method of forming the oil repellent film directly on the surface of a target object through vapor deposition or plasma polymerization.

The method using vapor deposition and the like requires large-scale equipment. Dipping and spin-coating are not suitable for the application of the solution to desired portions. Since brushes deformat the tip, it is also difficult to apply the solution to desired portions through brushing-on. And besides, the oil repellent tends to become solidified and stick to the portion around the brush tip as the solvent volatilizes, which impairs flexibility of the brush and thus materially lowers working efficiency of the application operation. Moreover, since lumps of the oil repellent frequently adhere to the target object, this method is extremely unsuitable especially for the use in mass-production of precision components.

US 2004/187955 A1 discloses a method in which a pair of nozzles are used to apply the solution of oil repellent to a desired portion of the target object in a non-contacting manner with the tips of the nozzles arranged close to each other. One of the nozzles discharges and supplies the oil repellent while the other nozzle sucks a portion of the solution by means of depressurization. According to the method, a sufficient amount of the oil repellent is constantly supplied, whereby the lumps of the solidified oil repellent are hardly produced even when the solvent volatilizes more or less. In this method, however, the solution of oil repellent needs to be supplied in an amount far larger than the amount to be actually applied to the target object, thereby increasing the cost for the solution of oil repellent. This accompanies increase in the amount of use of the organic solvent, which is not favorable from an environmental point of view. Further, since the application of the solution is performed in the state where the nozzles and the target object are separated, it is somewhat difficult to perform precise application.

### SUMMARY OF THE INVENTION

According to preferred embodiments of the present invention a method of applying a solution prepared by dissolving an oil repellent in a volatile solvent onto a surface of an object is provided. In the method, the object and an applicator operable to supply the solution are arranged with an end of the applicator and the object substantially away from each other; the solution is supplied from a solution reservoir operable to store the solution to the applicator through a solution passage connecting the solution reservoir and the applicator to each other; and the solution is made to ooze from the end of the applicator while one of the object and the applicator is moved relative to the other. A space between the object and the end of the applicator is filled with the solution. A distance between the object and the end of the applicator is determined to allow the solution to be held in the space by surface tension.

The applicator includes a channel through which the solution flows and which imparts a larger viscosity resistance than the solution passage.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 shows an exemplary application system used in an application method according to a first preferred embodiment of the present invention.

FIG. 2A is an enlarged view of an application device of the application system of FIG. 1.

FIG. 2B is an enlarged view of an end of the application device of FIG. 2A.

FIG. 3A shows a portion of an exemplary application system used in an application method according to a second preferred embodiment of the present invention.

FIG. 3B shows an exemplary application device used in the application method according to the second preferred embodiment of the present invention.

FIG. 4A shows an applicator used in an application method according to a third preferred embodiment of the present invention as viewed from an end thereof.

FIG. 4B is a cross-sectional view of the applicator of FIG. 4A, taken along a longitudinal direction thereof.

FIG. 5A shows an exemplary applicator used in an application method according to a fourth preferred embodiment of the present invention.

FIG. 5B shows another exemplary applicator used in the application method according to the fourth preferred embodiment of the present invention.

FIG. 6A shows an exemplary applicator used in an application method according to a fifth preferred embodiment of the present invention.

FIG. 6B shows another exemplary applicator used in the application method according to the fifth preferred embodiment of the present invention.

FIG. 7 shows an exemplary applicator used in an application method according to a sixth preferred embodiment of the present invention.

### DETAILED DESCRIPTION OF PREFERRED EMBODIMENTS

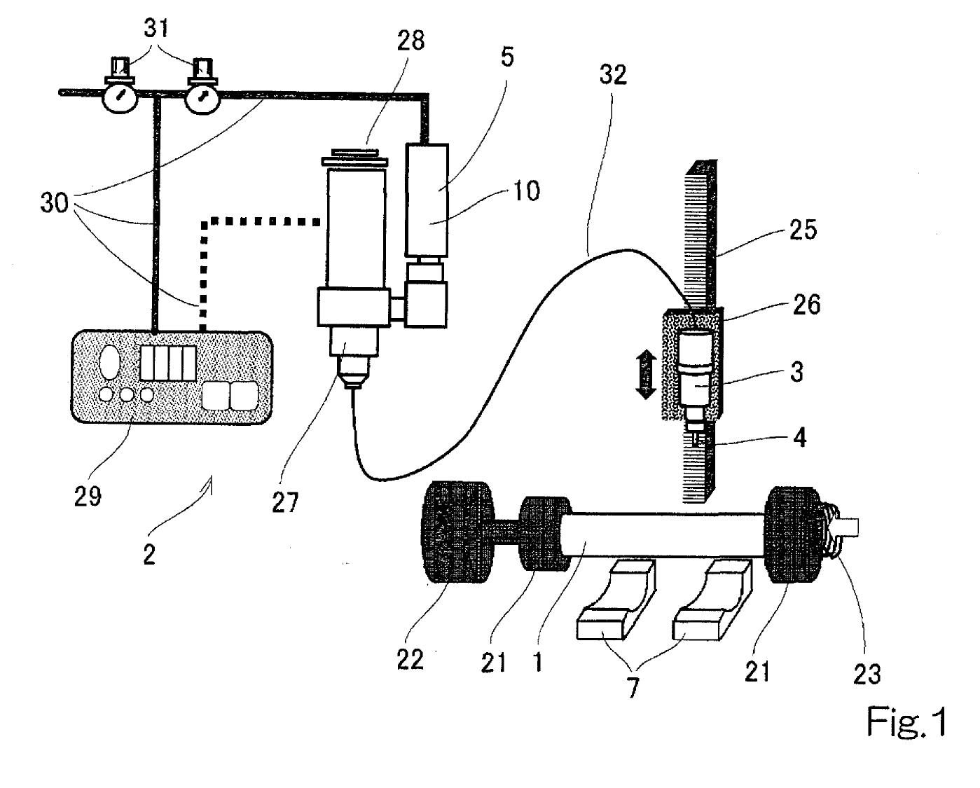

Referring to FIGS. 1 through 7, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated.

### First Preferred Embodiment

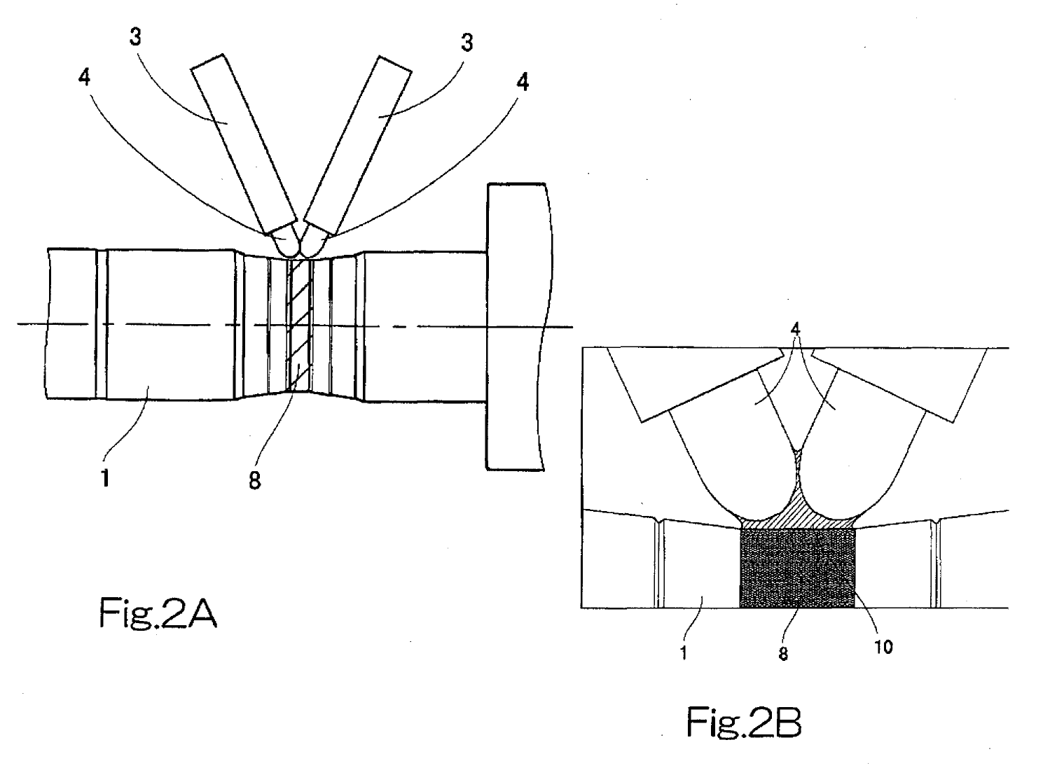

A method of applying a solution of an oil repellent according to a first preferred embodiment of the present invention is now described, referring to FIGS. 1, 2A, and 2B. In this preferred embodiment, a solution prepared by dissolving an oil repellent in a volatile solvent (hereinafter, simply referred to as an oil repellent solution) is supplied from a solution reservoir capable of storing the oil repellent solution to an applicator connected to the solution reservoir with a solution passage. The applicator is arranged away from a surface of an object on which an oil repellent film is to be formed (hereinafter, simply referred to as a target object). The oil repellent solution is supplied from the applicator to form a liquid film of the oil repellent solution on an end of the applicator which faces the target object. By making the liquid film come into contact with the surface of the target object, the oil repellent solution is transferred onto the surface of the object.

FIG. 1 shows an application system 2 which coats the oil repellent solution on the target object 1. In this preferred embodiment, the target object 1 is a substantially columnar shaft forming a portion of a spindle motor for use in a hard disk drive, for example. In spindle motors, an oil repellent film is usually formed on the surface of the shaft for preventing leak of lubricating oil to the outside. Typically, the oil repellent film is formed by applying a solution prepared by dissolving an oil repellent in a highly volatile solution to the surface of the shaft and drying it. An example of the oil repellent is fluorine resin. When the fluorine resin oil repellent is used, the oil repellent solution is prepared to have concentrations of several percents or lower.

Referring to FIG. 1, the structure of the application system 2 is described. The shaft 1, which has a diameter of 4 mm, for example, is held by an object receiving portion 7 which receives the shaft 1 and a holding device 21 which holds the shaft 1 at axial ends. The object receiving portion 7 is made of resin, for example. Two or more object receiving portions 7 may be provided in the application system 2, as shown in FIG. 1. In this case, the object receiving portions 7 may be arranged on both sides of a target portion onto which the oil repellent solution is to be applied in an axial direction parallel to a center axis of the shaft 1, for example. In this preferred embodiment, the shaft 1 is substantially columnar as described above, and each object receiving portion 7 has a concave surface to be in contact with the shaft 1. The diameter of the concave surface in a cross section of the object receiving portion 7 perpendicular to the axial direction of the shaft 1 is slightly larger than the diameter of the shaft 1.

At one axial end of the shaft 1, a pushing jig 23 is disposed on the opposite side of the shaft 1 to the holding device 21. The pushing jig 23 axially pushes the shaft 1 against the holding device 21 disposed at the other axial end of the shaft 1 and connected to a rotating mechanism 22. The rotating mechanism 22 rotates the shaft 1 about the center axis of the shaft 1 at about 30 rpm, for example. In this preferred embodiment, since application of the oil repellent solution onto the shaft 1 is carried out in a non-contact manner, a resistance force which is caused by rotation of the shaft 1 and acts on the holding device 21 is not large. Therefore, the holding device 21 only has to be able to hold the shaft 1 with a relatively small holding force. For example, an air chuck can be used.

An applicator 4 which supplies the oil repellent solution is provided in an end portion of an application device 3. The applicator 4 has a channel through which the oil repellent solution flows and which is opened at an end of the applicator 4. From this opening at the end of the applicator 4, the oil repellent solution oozes. The channel is in communication with the solution reservoir for supplying the oil repellent solution via the solution passage (tube 32 in this preferred embodiment). Therefore, the channel in the applicator 4 and the solution passage form a single continuous path for the oil repellent solution. The continuous path is narrower at least in a region of the applicator 4 including the object-side end than at the solution passage. The channel in the applicator 4 has such a diameter that the oil repellent solution can ooze from the end of the applicator 4 at a desired rate.

The application device 3 is attached to a holder 26 slidable on a sliding mechanism 25. In this preferred embodiment, the sliding mechanism 25 and the holder 26 are arranged to change a distance between the application device 3 and the shaft 1 in a direction substantially perpendicular to the axial direction of the shaft 1.

The oil repellent solution 10 prepared to contain the oil repellent at the aforementioned concentration is stored in a tank 5 (solution reservoir) which is connected to an air pipe line 30. Compressed air is sent to the tank 5 through the air pipe line 30 so as to push the oil repellent solution 10 out from the tank 5. That is, the compressed air from the air pipe line 30 serves as a pressure source. For example, a flow of compressed air of approximately 0.3 MPa supplied through air piping (not shown) in a factory or the like where the application system 2 is installed is split via a gauge valve 31 into two flow paths. The compressed air in one flow path is used for sending the oil repellent solution 10 from the tank 5, after the pressure thereof is reduced to approximately 7 kPa. The compressed air of approximately 0.3 MPa in the other flow path is used for driving a dispenser 27 and is supplied to a valve controlling device 29 via another air pipe line 30. In order to apply the oil repellent solution 10 onto the shaft 1, the compressed air controlled by the valve controlling device 29 is supplied to a valve of the dispenser 27 so as to open the valve.

An exemplary process for applying the oil repellent solution 10 on a surface of the target object 1 is now described.

In this preferred embodiment, the oil repellent solution 10 is supplied from the opening of the applicator 4 onto the surface of the shaft 1 in a region where the oil repellent solution is to be applied, while the shaft 1 is rotated about its center axis. In this operation, the applicator 4 and the shaft 1 are kept in a non-contact manner. The distance between the end of the applicator 4 and the surface of the shaft 1 is determined in such a manner that a liquid film of the oil repellent solution 10 is formed on an end surface of the applicator 4 and the oil repellent solution 10 is held by surface tension without flowing from a region where the end of the applicator 4 and the surface of the shaft 1 are opposed to each other. The applicator 4 has a channel therein through which the oil repellent solution 10 can flow to the end of the applicator 4. The diameter of the channel in the applicator 4 is smaller at least in an end portion thereof than that of the tube 32. Thus, the applicator 4 can supply the oil repellent solution 10 in small amounts. The small amount of the oil repellent solution 10 supplied from the end of the applicator 4 forms a liquid film on the end of the applicator 4.

In the beginning of the application process, the application device 3 is secured to the holder 26. The positional relationship between the application device 3 and the shaft 1 is then adjusted by sliding the holder 26, so that the application device 3 and the shaft 1 are arranged with the end of the applicator 4 and the surface of the shaft 1 away from each other by the aforementioned distance. Then, compressed air sent from the valve controlling device 29 to the valve of the dispenser 27 is controlled to open the valve, while the shaft 1 is rotated. Thus, the oil repellent resolution 10 starts to flow from the tank 5 to the application device 3 through the tube 32. A portion of the oil repellent solution 10 oozes from the end of the applicator 4 and forms a liquid film on the end of the applicator 4. When the oozing amount of the oil repellent solution 10 reaches a predetermined amount, a portion of the liquid film comes into contact with the surface of the shaft 1. In this state, the oil repellent solution 10 is continuously supplied from the end of the applicator 4 to the surface of the shaft 1 while the shaft 1 is rotated. In this manner, the oil repellent solution 10 can be continuously transferred onto a target region on the surface of the shaft 1, in which the oil repellent solution 10 is to be applied.

The oil repellent solution 10 on the surface of the shaft 1 is made smooth by rotation of the shaft 1. Thus, it is possible to form a layer of the oil repellent solution 10 having a substantially uniform thickness. In order to improve uniformity of the layer of the oil repellent solution 10, it is preferable that the oil repellent solution 10 be applied at least at a staring point of the application two or more times. In this preferred embodiment, the oil repellent solution 10 is applied on the surface of the shaft 1 in the target region three times.

In this preferred embodiment, the applicator 4 and the shaft 1 are arranged with the distance between the end of the applicator 4 and the surface of the shaft 1 set to a predetermined distance, and thereafter supply of the oil repellent solution 10 starts so as to form a liquid film of the oil repellent solution 10 on the end of the applicator 4. However, the present invention is not limited thereto. For example, the following procedure may be used in which the supply of the oil repellent solution 10 starts to cause the oil repellent solution 10 to ooze from the end of the applicator 4; the end of the applicator 4 is brought into contact with the surface of the shaft 1; and the end of the applicator 4 is moved away from the surface of the shaft 1 with the oozing portion of the oil repellent solution 10 held between the applicator 4 and the shaft 1.

When the application is stopped, the supply of the oil repellent solution 10 from the tank 5 is stopped by closing the valve of the dispenser 27 via the valve controlling device 29. Then, the application device 3 is moved away from the shaft 1, for example, to a position at which the application device 3 does not obstruct removal of the shaft 1 from the holding device 21. During the above operations, i.e., the operation for stopping the supply of the oil repellent solution 10 and the operation for moving the application device 3, the shaft 1 continues to be rotated. Thus, the oil repellent solution 10 remaining in the channel in the applicator 4 and between the end of the applicator 4 and the surface of the shaft 1 continues to be transferred to the region on the surface of the shaft 1 in which the oil repellent solution 10 is to be applied. After the transfer of the oil repellent solution 10 is stopped, the shaft 1 continues to be rotated for a predetermined period. In this preferred embodiment, the shaft 1 is continuously rotated for about 5 seconds, for example. This rotation of the shaft 1 can make the layer of the oil repellent solution 10 on the surface of the shaft 1 smooth and can volatilize the solvent in the oil repellent solution 10. After the oil repellent solution 10 is dried, the rotation of the shaft 1 is stopped. Then, the shaft 1 is removed from the object receiving portions 7 and the holding device 21, and the next shaft 1 is then mounted on the object receiving portions 7. The above-described procedure is performed for the next shaft 1 so as to apply the oil repellent solution 10 on the surface of the next shaft 1.

During the application process or during the rotation of the shaft 1 after the application is finished, the condition of the oil repellent solution 10 on the surface of the shaft 1 may be checked and at least one parameter for changing the condition of the applied oil repellent solution 10 may be changed based on the check result. Examples of the parameters are the distance between the end of the applicator 4 and the surface of the shaft 1 and the pressure of the compressed air for sending the oil repellent solution 10 from the tank 5.

In this preferred embodiment, the distance between the surface of the shaft 1 and the end of the applicator 4 has to be smaller than a droplet of the oil repellent solution 10 formed when the oil repellent solution 10 oozes from the end of the applicator 4. The optimum distance between the end of the applicator 4 and the surface of the shaft 1 is varied depending on the type of the solvent in the oil repellent solution 10, the type and the concentration of the oil repellent dissolved in the solvent, and the like. Thus, in a case where the condition of the applied oil repellent solution 10 is checked during the application process, for example, the distance between the end of the applicator 4 and the surface of the shaft 1 is set to approximately 10% of the axial width of the target region on the surface of the shaft 1. After the shaft 1 and the applicator 4 are arranged with the above distance therebetween, the oil repellent solution 10 is applied onto the shaft 1 and the condition of the applied oil repellent solution 10 is checked. Then, the distance between the shaft 1 and the end of the applicator 4 is adjusted based on the check result, if necessary. The adjustment of the distance between the shaft 1 and the end of the applicator 4 is achieved by sliding the holder 26, for example. In addition to the distance between the shaft 1 and the end of the applicator 4, the pressure of the compressed air for sending the oil repellent solution 10 from the tank 5 may be adjusted. The adjustment of the pressure of the compressed air is carried out by using a stroke adjustment screw 28, for example.

In some cases, there are air bubbles in the tube 32 when the application process begins. The air bubbles should be removed before the application of the oil repellent solution 10 starts. In a case where the applicator 4 is not used for a while, it is necessary to close the opening of the end of the applicator 4 in order to prevent volatilization of the solvent in the oil repellent solution 10 which causes solidification of the oil repellent.

In order to improve productivity, the pressure of the compressed air for sending the oil repellent solution 10 from the tank 5 may be increased. The increase in the air pressure increases an oozing rate of the oil repellent solution 10 at the end of the applicator 4. Thus, it is possible to apply the oil repellent solution 10 in a shorter time. Please note that the air pressure has to be determined considering surface tension of the oil repellent solution 10 at the end of the applicator 4.

The applicator 4 is now described referring to FIGS. 2A and 2B. FIG. 2A shows the applicator 4 and the shaft 1. FIG. 2B is an enlarged view of the end of the applicator 4.

The application method of this preferred embodiment uses two applicators 4, although only one applicator 4 is shown in FIG. 1 for simplifying the explanation. Other components of the application system 2, i.e., the sliding mechanism 25 and the dispenser 27, are provided for every applicator 4. In FIGS. 2A and 2B, components of the application system 2 other than the application devices 3 are omitted for simplifying the explanation.

In this preferred embodiment, two application devices 3 in each of which the applicator 4 having a round end is provided are used. In the example of FIGS. 2A and 2B, the two applicators 4 are arranged in a V-shape in which the ends of the applicators 4 form an acute angle. In other words, the two applicators 4 are arranged such that the ends thereof are adjacent to each other and the distance between the applicators 4 increases in a direction away from the shaft 1. The ends of the applicators 4 are in contact with each other or away from each other. It is only necessary that the gap between the ends of the applicators 4 and the surface of the shaft 1 is filled with the oil repellent solution 1. With this arrangement, a region between the ends of the applicators 4 and the surface of the shaft 1, in which the oil repellent solution 10 is held by surface tension, can be widened in the axial direction. Thus, it is possible to apply the oil repellent solution 10 in an axially wider region on the surface of the shaft 1, as compared with a case of using only one applicator 4.

The distance between the ends of the applicators 4, an angle at which each applicator 4 is arranged with respect to the shaft 1 or the other applicator 4 may be changed so as to adjust the axial length of the region on the surface of the shaft 1 in which the oil repellent solution 10 is applied. Moreover, in a case where at least two application devices 3 are used, the structures of the applicators 4 thereof may be different from each other and/or the concentrations of the oil repellent solution 10 from the ends of the respective applicators 4 may be different.

In the example of FIGS. 2A and 2B, the application devices 3 (applicators 4) are arranged substantially along the axial direction of the shaft 1. However, the arrangement of the application devices 3 is not limited thereto. For example, the application devices 3 (applicators 4) may be arranged along a rotating direction of the shaft 1, i.e., along a circumferential direction of the shaft 1 which is substantially columnar. This arrangement is advantageous, for example, in a case where during one revolution of the shaft 1 the oil repellent solution 10 loses liquidity and the oil repellent is solidified. In this case, a plurality of application devices 3 (applicators 4) may be arranged along the rotating direction of the shaft 1 at appropriate intervals. With this arrangement, it is possible to apply the oil repellent solution 10 two or more times on the surface of the shaft 1 during one revolution of the shaft 1. Please note that the rotation speed of the shaft 1 can be appropriately chosen.

Although two application devices 3 are used in this preferred embodiment, only one application device 3 can be used when the width of the region on the surface of the shaft 1 in which the oil repellent solution 1 is to be applied is not large. Moreover, in order to apply the oil repellent solution 10 in a wider region on the surface of the shaft 1, three application devices 3 may be used which are arranged to form a triangular pyramid. The number of the application devices 3 is not limited to the above. That is, four or more application devices may be used.

In this preferred embodiment, the oil repellent solution 10 is applied on the outer circumferential surface of the substantially columnar shaft 1 for use in a spindle motor. However, the target object 1 is not limited thereto. For example, the application method of this preferred embodiment can be used in a case of applying the oil repellent solution 10 onto another component of the spindle motor, e.g., a sleeve, and an inner surface and an axial end surface of a hub.

According to the application method of this preferred embodiment, the small amount of the oil repellent solution 10 is held at the end of the applicator 4 by surface tension of the oil repellent solution 10, and the end of the applicator 4 and the surface of the shaft 1 are kept in a non-contact state. Thus, it is possible to reduce solidification on the oil repellent caused by volatilization of the solvent in the oil repellent solution 10 on the surface of the target object 1. On the other hand, although the applicator 4 and the shaft 1 are away from each other, they are arranged close to each other to such a degree that the liquid film of the oil repellent solution 10 formed on the end of the applicator 4 is in contact with the surface of the shaft 1. Therefore, the oil repellent solution 1 can be applied in a region on the surface of the shaft 1, which has the same width as that of the end of the applicator 4. That is, it is possible to carry out precise application of the oil repellent solution 10. In addition, it is possible to prevent the surface of the shaft 1 from being damaged by contact with the end of the applicator 4, because the end of the applicator 4 and the surface of the shaft 1 are not in contact with each other.

### Second Preferred Embodiment

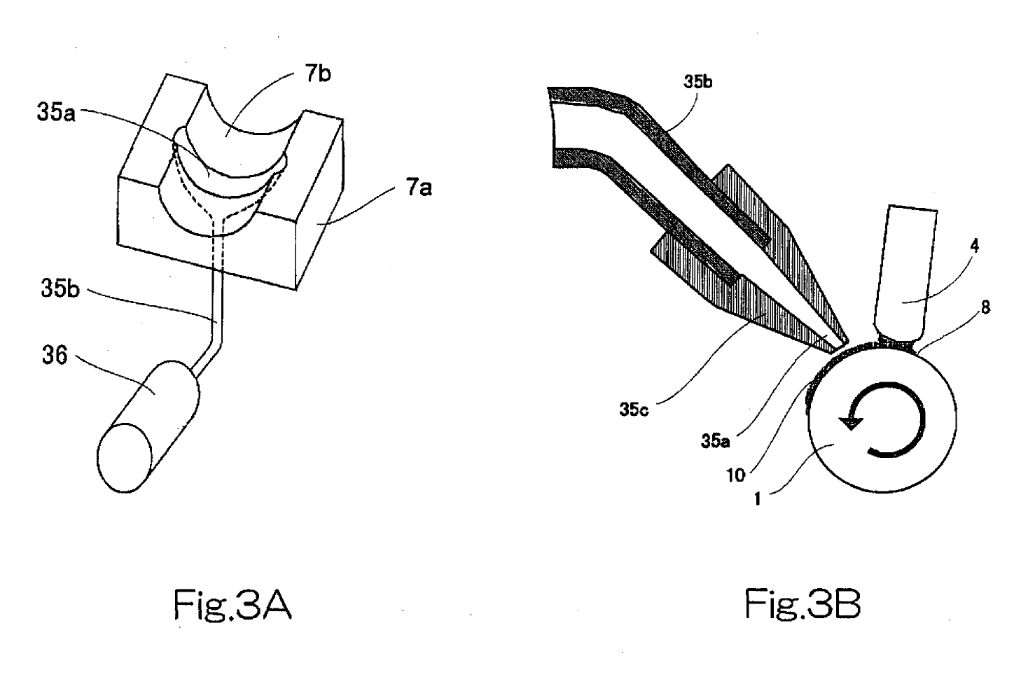

An application method according to a second preferred embodiment of the present invention is now described referring to FIGS. 3A and 3B. In this preferred embodiment, a suction arrangement is provided near the target object, and suction is carried out while the oil repellent solution is applied onto the target object. Except for those points, this preferred embodiment is the same as the first preferred embodiment described above. Therefore, like parts are given like reference numerals in the description of this preferred embodiment and FIGS. 3A and 3B and the detailed description thereof is omitted.

FIG. 3A shows an example in which a portion of the suction arrangement is integrated with an object receiving portion 7a which receives the target object. A curved surface 7b of the object receiving portion 7a, which is to face the target object 1 (hereinafter, simply referred to a receiving surface 7b), is provided with a suction port 35a which is a portion of the suction arrangement. The suction port 35a is arranged at a position corresponding to the target region on the surface of the target object 1 in which the oil repellent solution 10 is to be applied. The suction port 35a is connected to a suction pump 36 via a suction pipe 35b. When the suction pump 36 sucks air, a flow of air toward the suction port 35a is created around the receiving surface 7b. In addition, a portion of the oil repellent solution 10 may be sucked into the suction port 35a. Therefore, even if the oil repellent solution 10 is supplied excessively, the excess portion of the oil repellent solution 10 can be sucked and removed.

The use of the suction arrangement together with the application system can improve safety. In addition, it is possible to set the pressure of the compressed air for sending the oil repellent solution 10 from the tank 5 to a higher pressure in this preferred embodiment. Thus, the amount of the oil repellent solution 10 oozing from the end of the applicator 4 can be set to be larger. This shortens takt time. However, the cost of installing equipment and the wasteful use of the oil repellent solution 10 are increased in this case. Therefore, selection of whether or not to use the suction arrangement should be done in accordance with situations.

FIG. 3B shows another exemplary suction arrangement. In the example of FIG. 3B, the suction arrangement is provided separately from the object receiving portion. The suction arrangement includes a suction nozzle 35c having a suction port 35a at its end. The suction nozzle 35c is arranged with the suction port 35a located near the end of the applicator 4. The suction port 35a is connected to a space inside the suction nozzle 35c. This space serves as a suction pipe 35b. The suction port 35a is connected to a suction pump (not shown) via the suction pipe 35b. The use of the suction arrangement independent from the object receiving portion as shown in FIG. 3B enables fine adjustment of the position at which suction is to be carried out.

The use of the suction arrangement is advantageous, for example, in a case where the oil repellent solution 10 held in a region between the end of the applicator 4 and the surface of the shaft 1 flows out from the region because of vibration or the like. This causes the oil repellent solution to be applied in an unwanted region on the surface of the target object 1. However, when the suction port is arranged near the applicator 4, it is possible to make a flow of air act on the region where the oil repellent solution 10 has been applied. Therefore, failure of application of the oil repellent solution can be reduced.

### Third Preferred Embodiment

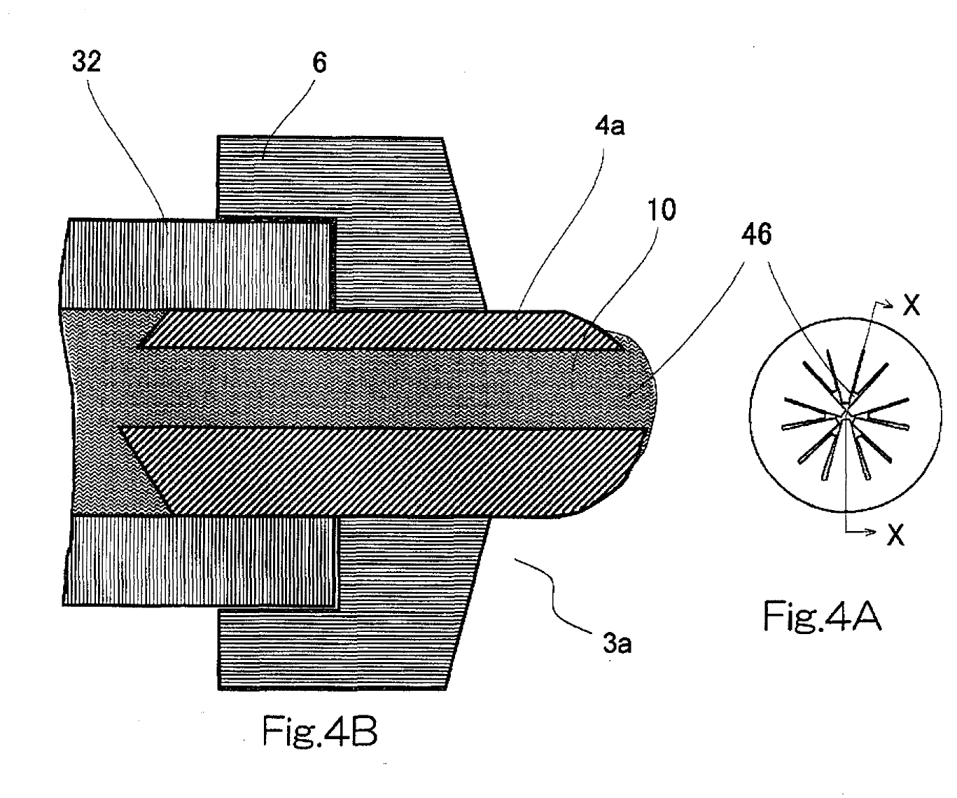

An application method and an application device according to a third preferred embodiment of the present invention are now described, referring to FIGS. 4A and 4B. This preferred embodiment is the same as the first preferred embodiment except for the structure of the application device. Therefore, like parts are given like reference numerals in the following description and FIGS. 4A and 4B, and the detailed description thereof is omitted.

FIG. 4A shows the shape of the end portion of the applicator 3a. FIG. 4B is a cross-sectional view of the end of the applicator 3a taken along line X-X in FIG. 4A. In this preferred embodiment, the channel inside the applicator 4a for the oil repellent solution 10 is formed by combining a plurality of thin spaces each extending along the longitudinal direction of the applicator 4a. Each space is thinner than the solution passage for supplying the oil repellent solution 10 to the applicator 4a. For example, the channel in the applicator 4a has a cross-sectional shape obtained by combining a plurality of slits on a plane perpendicular to the longitudinal direction of the applicator 4a. At the end of the applicator 4a is located an opening end of the channel as an opening 46. The applicator 4a is made of resin, for example. The application device 3a also includes a sheath 6 which accommodates the applicator 4a therein. FIG. 4A shows a state where a portion of the oil repellent solution 10 oozes through the opening 46 of the applicator 4a. The oozing portion of the oil repellent solution 10 forms a liquid film on an end surface of the applicator 4a.

As shown in FIG. 4B, the tube 32 which allows the oil repellent solution 10 to flow therethrough from the tank 5 to the application device 3a is inserted into the sheath 6. Thus, in this preferred embodiment, it is possible to connect the tube 32 to the applicator 4a substantially without leak of the oil repellent solution 10 only by inserting the tube 32 into the sheath 6. Moreover, the arrangement in this preferred embodiment allows relatively easy change of the structure of the applicator 4a. In addition, if the sheath 6 having a sufficiently rigidity is used, the rigidity of the entire application device 3a can be enhanced. Thus, it is possible to perform application of the oil repellent solution precisely and stably.

### Fourth Preferred Embodiment

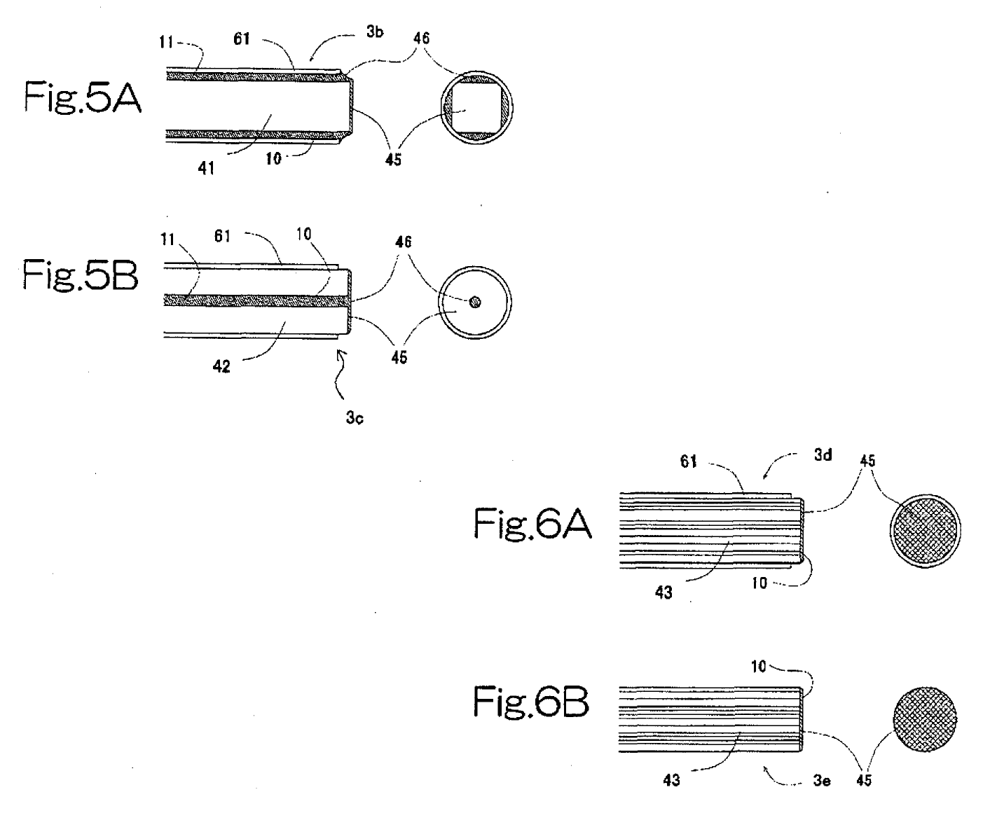

An application method and an application device according to a fourth preferred embodiment of the present invention are now described, referring to FIGS. 5A and 5B. This preferred embodiment is the same as the first preferred embodiment except for the structure of the application device. Therefore, like parts are given like reference numerals in the following description and FIGS. 5A and 5B, and the detailed description thereof is omitted.

FIG. 5A shows an exemplary application device 3b used in this preferred embodiment. A cross-section of an applicator 41 arranged in an end portion of the application device 3b is shown in the left part of FIG. 5A, and the shape of the end of the applicator 41 when viewed therefrom is shown in the right part of FIG. 5A.

The application device 3b of FIG. 5A includes an applicator 41 in the form of a substantially quadrangular prism, for example, and a sheath 61 which accommodates the applicator 41 therein. In this example, the sheath 61 extends along the applicator 41 and has a generally circular cross-section on a plane perpendicular to the longitudinal direction of the applicator 41. Minute gaps 11 which extend along the longitudinal direction of the applicator 41, as shown in the left part of FIG. 5A, are formed between the outer surface of the applicator 41 and the inner surface of the sheath 61. As shown in the right part of FIG. 5A, the minute gaps 11 are formed at four locations along the circumference of the applicator 41. The minute gaps 11 are in communication with the inside of the tank 5 and are filled with the oil repellent solution 10 supplied from the tank 5. One end of each minute gap 11 is opened at the end of the applicator 41 and serves as the opening 46. An end surface 45 of the applicator 41 is adjacent to the opening 46. A portion of the oil repellent solution 10 oozing from the opening 46 forms a liquid film on the end surface 45 by surface tension of the oil repellent solution 10. During the application process, the distance between the applicator 41 and the target object 1 is set to an appropriate distance in the manner described in the first preferred embodiment. Thus, the liquid film of the oil repellent solution 10 comes into contact with the surface of the target object 1, so that the oil repellent solution 1 is transferred onto the surface of the target object 1.

FIG. 5B shows another exemplary application device 3c used in this preferred embodiment. The left part of FIG. 5B shows a cross section of an end portion of an applicator 42 provided in the application device 3c, taken along the longitudinal direction of the applicator 42. The right part of FIG. 5B shows the shape of the applicator 42 when viewed from the end thereof. The applicator 42 is different from the applicator 41 in the example of FIG. 5A in the shape. That is, the applicator 42 is substantially cylindrical and is therefore accommodated in the sheath 61 which is also substantially cylindrical with substantially no space between the applicator 42 and the sheath 61. The applicator 42 has a minute gap 11 extending along the longitudinal direction thereof. The minute gap 11 is arranged at or around the center of the applicator 42 on a cross section of the applicator 42 perpendicular to the longitudinal direction of the applicator 42, as shown in FIG. 5B. The minute gap 11 is in communication with the inside of the tank 5 and is filled with the oil repellent solution 10. An opening end of the minute gap 11 at the end of the applicator 42 forms the opening 46 which is arranged at or around the center when the applicator 42 is viewed from its end. The end surface 45 of the applicator 42 is adjacent to the opening 46. A portion of the oil repellent solution 10 oozing from the opening 46 forms a liquid film on the end surface 45 by surface tension of the oil repellent solution 10. In a case of using the application device 3c of FIG. 5B, occurrence of solidification of the oil repellent at the opening end of the minute gap 11 during the application process since the minute gap 11 is arranged not around the applicator 42 but at the center of the applicator 42.

In the examples of FIGS. 5A and 5B, the use of the sheath 61 having a sufficient rigidity can increase the rigidity of the entire application device. Thus, it is possible to perform the application of the oil repellent solution 10 precisely and safely. Moreover, the use of the sheath 61 can minimize volatilization of the solvent in the oil repellent solution 10 before the oil repellent solution 10 reaches the end of the applicator.

### Fifth Preferred Embodiment

An application method and an application device according to a fifth preferred embodiment of the present invention are described, referring to FIGS. 6A and 6B. This preferred embodiment is the same as the fourth preferred embodiment except for the structure of the application device. Thus, like parts are given like reference numerals in the following description and FIGS. 6A and 6B, and the detailed description thereof are omitted.

FIG. 6A shows a cross section of an application device 3d used in this preferred embodiment, taken along its longitudinal direction, and also shows the shape of the application device 3d when viewed from its end. In the example of FIG. 6A, the applicator 43 is formed by a plurality of fibers or fiber-like members (hereinafter, collectively referred to as fibers) which extend along the longitudinal direction of the applicator 43 with minute gaps therebetween. The minute gaps allow the oil repellent solution 10 to flow therethrough. That is, the minute gaps serve as channels which are in communication with the solution passage. Thus, the channels in the applicator 43 are also thinner than the solution passage which supplies the oil repellent solution 10 to the applicator 43.

The applicator 43 is accommodated in the sheath 61. Thus, the rigidity of the end portion of the application device 3d is ensured by the rigidity of the sheath 61. Another end of the applicator 43 (not shown) is connected to the tank 5 via the solution passage through which the oil repellent solution 10 is supplied to the applicator 43. A portion of the oil repellent solution 10 oozes from the object-side end of the applicator 43 to form a liquid film on an end surface of the applicator 43.

FIG. 6B shows another application device 3e having a simpler structure than the application device 3d of FIG. 6A. In the example of FIG. 6B, the applicator 3e is different from the applicator 3d in that there is no sheath 61. Except for that point, the applicator 3e is the same as the applicator 3d. Since the applicator 3e has no sheath 61, the rigidity of the applicator 3e is provided by the rigidity of the applicator 43 only. Thus, the applicator 3e can be more largely deformed than the applicator 3d if it comes in contact with the target object 1. However, the applicator 3e can have a sufficient rigidity by appropriately choosing the material for the applicator 43. The applicator 3e is usually used in a state where it is not in contact with the target object 1. Therefore, there is large margins of strength and rigidity of the applicator 3e. Thus, it is possible to perform the application of the oil repellent solution 10 smoothly even by means of the applicator 3e of FIG. 6B.

Since the applicator 3e of FIG. 6B has no sheath 61, the amount of volatilized solvent from side surfaces (surfaces parallel to the longitudinal direction) of the applicator 43 is relatively large. However, the solidified oil repellent resulting from volatilization of the solvent minimizes further volatilization of the solvent. Therefore, unlimited volatilization of the solvent does not occur.

### Sixth Preferred Embodiment

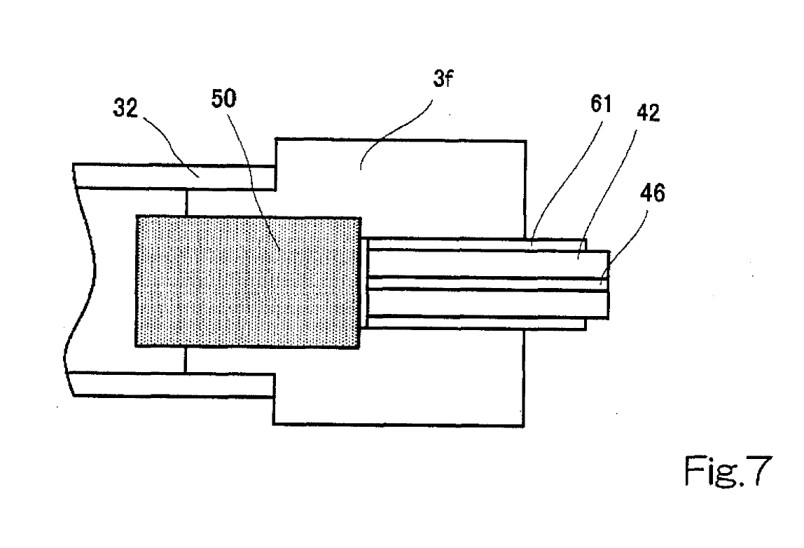

An application method and an application device according to a sixth preferred embodiment of the present invention are described referring to FIG. 7. In this preferred embodiment, an application device 3f includes a filter 50. In the application device 3f, the applicator 42 is accommodated in the sheath 61 and has a minor gap extending along the longitudinal direction of the applicator 42. In a cross section of the applicator 42 perpendicular to the longitudinal direction thereof, the minor gap is arranged at or around the center. The minor gap is opened at the end of the applicator 42 and forms the opening 46.

The tube 32 which supplies the oil repellent solution 10 from the tank 5 to the applicator 42 is attached to the application device 3f. At a connection between the inside of the tube 32 and the channel in the applicator 42, the filter 50 is disposed in order to increase flow resistance at that portion. The filter 50 is formed by a plurality of absorption fibers. Inside the filter 50 are formed capillaries which prevent a large amount of the oil repellent solution 10 from flowing therethrough at a time. Since the filter 50 can also prevent air from flowing toward the tank 5, it is possible to hold the oil repellent solution 10 near the applicator 42. This can shorten a time required for starting up of next application of the oil repellent solution 10 after a new target object 1 is mounted. Moreover, it is also possible to easily exchange the filter 50 to a new one even if the filter 50 is clogged.

The filter 50 is made of chemical fibers, for example. However, the material for the filter 50 is not limited thereto. For example, the filter 50 may be made of porous metal material or formed by fine particles.

In this preferred embodiment, a path for the oil repellent solution from the tank 5 to the end of the applicator 42 (including the tube 32, the portion where the filter 50 is arranged, and the channel in the applicator 42) becomes narrower toward the end of the applicator 42, as in the aforementioned preferred embodiments. Therefore, it is possible to prevent the oil repellent solution 10 from oozing from the end of the applicator 42 excessively.

In the above preferred embodiments, the description is made by referring to a substantially columnar shaft as the target object. However, the target object is not limited thereto. For example, the present invention is applied to a case of applying the oil repellent solution onto an inner circumferential surface of a substantially cylindrical bearing sleeve, if the end of the applicator can be brought close to the inner circumferential surface of the bearing sleeve. Moreover, the present invention can be applied not only to a curved surface but also to a flat surface of a machine component.

In the above preferred embodiments, the method of applying the oil repellent solution onto the shaft of the spindle motor is described as an example. However, the present invention is not limited to application of the oil repellent solution. The present invention can be used for applying a low-viscosity solution of resin in which a solvent can be easily volatilized to cause solidification, onto an object.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method of applying a solution prepared by dissolving an oil repellent in a volatile solvent onto a surface of an object, comprising:
arranging the object and an applicator operable to supply the solution with an end of the applicator and the object substantially away from each other;
supplying the solution from a solution reservoir operable to store the solution to the applicator through a solution passage connecting the solution reservoir and the applicator to each other; and
making the solution ooze from the end of the applicator while one of the object and the applicator is moved relative to the other, wherein
a space between the object and the end of the applicator is filled with the solution and a distance between the object and the end of the applicator is determined to allow the solution to be held in the space by surface tension.

2. The method as claimed in claim 1, wherein the supplying of the solution includes:
starting supply of the solution from the solution reservoir to the applicator with the end of the applicator and the surface of the object kept in a non-contact state; and
making a portion of the solution ooze from the end of the applicator to form a liquid film of the solution by surface tension, and
making the oozing portion of the solution come into contact with the surface of the object.

3. The method as claimed in claim 1, wherein the supplying of the solution includes:
bringing the end of the applicator and the surface of the object into contact with each other while no solution oozes from the end of the applicator;
making the solution ooze from the end of the applicator with the applicator in contact with the object; and
moving the object and the applicator away from each other with the solution in contact with both the surface of the object and the end of the applicator, until the object and the end of the applicator is away from each other by the distance.

4. The method as claimed in claim 1, wherein the supplying of the solution includes sending air to the solution reservoir to push the solution in the solution reservoir toward the applicator.

5. The method as claimed in claim 4, further comprising:
stopping the sending of the air to the solution reservoir to stop the supply of the solution to the applicator; and
separating the object and the applicator from each other, wherein
the stopping of the sending of the air and the separation of the object and the applicator are carried out while one of the object and the applicator are moved relative to the other.

6. The method as claimed in claim 1, wherein the object is a substantially columnar shaft, and the solution is made to ooze from the applicator while the object is rotated relative to the applicator.

7. The method as claimed in claim 6, further comprising:
stopping the supply of the solution from the solution reservoir; and
separating the shaft and the applicator from each other while rotating the shaft;
rotating the shaft for a predetermined period after the supply of the solution from the solution reservoir is stopped; and
stopping the rotation of the shaft.

8. The method as claimed in claim 7, wherein the rotation of the shaft is stopped after the solution on the shaft is made smooth and the volatile solvent is substantially volatilized.

9. The method as claimed in claim 1, further comprising:
checking a condition of the applied solution on the surface of the object; and
adjusting at least the distance between the object and the applicator based on the check result.

10. The method as claimed in claim 9, wherein
the supplying of the solution includes sending air to the solution reservoir to push the solution in the solution reservoir toward the applicator, and
a pressure of the air is adjusted based on the result of the check.

11. The method as claimed in claim 1, further comprising sucking an excess portion of the solution on the surface of the object.

12. The method as claimed in claim 1, wherein at least two applicators are used and arranged such that a distance between the applicators increases in a direction away from the surface of the object.

13. The method as claimed in claim 12, wherein a gap between ends of the applications is filled with a portion of the solution.

14. The method as claimed in claim 13, wherein a concentration of the solution oozing from one of the applicators is different from a concentration of the solution oozing from the other applicator or at least one of other applicators.

15. The method as claimed in claim 12, wherein the applicators are arranged at different positions along a circumference of the object.

16. The method as claimed in claim 1, wherein the object is a component of a bearing assembly or a shaft for use in a spindle motor.

17. The method as claimed in claim 1, wherein the applicator is a solid member and is accommodated in a sheath, opposing surfaces of the solid member and the sheath forming capillaries opened at the end of the applicator.

18. The method as claimed in claim 1, wherein the applicator is a solid member and is accommodated in a sheath and the solid member has at least one capillary at or around its center.

19. The method as claimed in claim 1, wherein a plurality of fibers form the applicator and a plurality of gaps are formed between the fibers to allow the solution from the solution reservoir to pass therethrough.

20. The method as claimed in claim 19, wherein the fibers are accommodated in a sheath for the applicator.

21. The method as claimed in claim 1, wherein a filter which makes flow resistance larger is provided between the applicator and the solution reservoir.

22. The method as claimed in claim 21, wherein the filter is made of porous material, or formed by fibers or particles.

23. The method as claimed in claim 1, wherein the surface of the object is curved or flat.

24. The method according to clam 1, wherein application of the solution is carried out two or more times at least at a start point of the application of the solution.

25. The method as claimed in claim 24, wherein the application of the solution is repeated multiple times such that each application of the solution is carried out after the volatile solvent in the solution applied in a previous application is volatilized.

26. The method as claimed in claim 1, wherein the oil repellent contains fluorine resin and the solution contains the fluorine resin at a concentration of several percents or less.

27. The method as claimed in claim 1, wherein the applicator includes a channel through which the solution flows, the channel imparting a larger viscosity resistance than the solution passage.
